(19) United States
(12) Patent Application Publication
(10) Pub. No.: US 2018/0097857 A1
(43) Pub. Date: Apr. 5, 2018

(54) WIRELESS CONFERENCING SYSTEM AND METHOD FOR CONFIGURING SAME

(71) Applicant: Televic Conference NV, Izegem (BE)

(72) Inventors: John GESQUIERE, Poperinge (BE); Vincent SOUBRY, Izegem (BE); Pieter CARDOEN, Passendale (BE); Stefaan VLAEMYNCK, Beernem (BE)

(73) Assignee: Televic Conference NV, Izegem (BE)

(21) Appl. No.: 15/560,650

(22) PCT Filed: Mar. 25, 2016
(86) PCT No.: PCT/EP2016/056709

§ 371 Date: Sep. 22, 2017

(30) Foreign Application Priority Data
Mar. 25, 2015 (EP) 15160935.1

(51) Int. Cl. H04L 29/06; H04L 12/703; H04W 72/04; H04W 40/24; H04W 40/34

(52) U.S. Cl. CPC H04L 65/403; H04L 45/28; H04W 40/34; H04W 40/24; H04W 72/04

(57) ABSTRACT

The invention pertains to a method for configuring a wireless conferencing system comprising conference terminals, each being equipped with a transceiver adapted to operate in an omnidirectional and a directional mode. In a discovery phase, for each pair of conference terminals, the directions in which direct wireless signal exchange is possible are discovered by pairwise operating a the terminals in omnidirectional and directional mode, one terminal being operated so as to vary a direction of operation. A direction in which direct signal exchange is possible is selected as an active transmission direction. In an operational phase, signals are sent between the conference terminals, using the active transmission direction. In a recovery phase, a second direction is selected as a new active transmission direction, and signals are sent between the terminals, using the new active transmission direction. The invention also pertains to a corresponding computer program product and system.

### FIELD OF THE INVENTION

The present invention pertains to wireless conferencing systems, and in particular to methods for configuring such systems.

### BACKGROUND

In conferencing systems, conference terminals (or “delegate units”) allow individual delegates to transmit and receive audio and optionally video, in particular delegates' speech and/or translations thereof, and data to and from each other, optionally via one or more centralized servers or access points.

In wireless conferencing systems, a relatively large number of conference terminals must be able to communicate with each other and/or with an access point via radio waves in a limited space and in a limited spectrum. The effectively available bandwidth in known systems is limited by the interference between transmissions from different conference terminals. Moreover, the configuration of such systems tends to be complicated and time consuming.

It is a purpose of embodiments of the present invention to provide a wireless conferencing system that has a more efficient spectrum use and that is easy to configure.

### SUMMARY OF THE INVENTION

According to an aspect of the present invention, there is provided a method for configuring a wireless conferencing system comprising a plurality of conference terminals in an indoor environment, each of the conference terminals being equipped with a transceiver adapted to operate in a first mode and a second mode, the first mode being an omnidirectional mode and the second mode being a directional mode, the method comprising: in a discovery phase, for each pair of conference terminals, discovering a number of directions in which a direct wireless exchange of signals between the pair of conference terminals is possible, by operating a first one of the pair of conference terminals in the first mode and a second one of the pair of conference terminals in the second mode and attempting to exchange first signals while the transceiver of the second conference terminal is operated so as to vary a direction of operation; for a first one of the plurality of conference terminals and a second one of the plurality of conference terminals, selecting a first one of the number of directions in which the direct wireless exchange of signals between the first one of the plurality of conference terminals and the second one of the plurality of conference terminals is possible as an active transmission direction; in an operational phase, sending second signals from the first one of the plurality of conference terminals to the second one of the plurality of conference terminals, using the active transmission direction; and, in a primary recovery phase, if a failure in the sending of the second signals is detected and if the discovering resulted in at least two directions in which the direct wireless exchange between the first one of the plurality of conference terminals and the second one of the plurality of conference terminals is possible, selecting a second one of the number of directions in which direct wireless exchange of signals between the first one of the plurality of conference terminals and the second one of the plurality of conference terminals is possible as a new active transmission direction, and sending third signals from the first one of the plurality of conference terminals to the second one of the plurality of conference terminals, using the new active transmission direction.

The present invention is based inter alia on the insight of the inventors that directional transmission (such as beam forming) can advantageously be used in wireless conferencing systems to use the available bandwidth more efficiently, by setting up the wireless network as a collection of directional point-to-point links rather than an omnidirectional broadcast network. The present invention is further based on the insight of the inventors that by judiciously using transceivers that can be switched between an omnidirectional mode and a directional mode, the conference terminals can be made to scan for directions in which direct wireless communication with other conference terminals is possible, thus simplifying the setting up of the conferencing system. In the present application, the term “direct wireless communication” or “direct wireless exchange” is used to designate wireless communication between two conference terminals via a directional transceiver, whether entirely through free space or using reflections off elements in the environment, without intervention of an intermediate (relaying) transceiver.

The “indoor environment” may be any conference room, conference hall, office space, dwelling, mall, or the like.

The “directional mode” may be a beam-forming mode or a mode using a sectorial antenna to substantially direct the power at the output of the antenna in a particular direction.

The “scanning”-based discovery process may be sped up by using a heuristic, for instance based on information about the geometry of the indoor space in which the conferencing system is deployed. This information may be provided specifically for the actual indoor space used, or it may be generic (such as, by way of example, the following set of assumptions: all conference terminals other than the access point are located at approximately the same desk height x, the access point is located at height x+d, there is a substantially horizontal ceiling surface at height y, the room is substantially rectangular).

It is an advantage of the present invention that multiple possible paths (directions) for direct wireless transmission between pairs of conference terminals are discovered, if available, and that a switch-over from one such path to another such path is performed when the first path becomes unavailable due to interference, fading, temporary presence of an obstacle in the path, or the like.

In an embodiment, the method according to the present invention further comprises: in a secondary recovery phase, if a failure in the sending of the second signals or the sending of the third signals is detected, sending fourth signals from the first one of the plurality of conference terminals to a third one of the plurality of conference terminals, using a first one of the number of directions in which the direct wireless exchange of signals between the first one of the plurality of conference terminals and the third one of the plurality of conference terminals is possible, the third one of the plurality of conference terminals being used as a relay for reaching the second one of the plurality of conference terminals.

It is a further advantage of this embodiment that if no path is available for direct wireless transmission between a given pair of conference terminals, communication is still made possible by switching-over to a relayed mode, where a third conference terminal takes up the role of a relay node. It will be understood that the link between any given pair of conference terminals may pass through multiple nodes, if necessary. It will be further understood that, in a given system, multiple pairs of conference terminals may be in a situation where no direct wireless communication is possible, and that the system is then in a mode where most links use relays; the system will then effectively operate as a meshed network.

Preferably, the secondary recovery phase is initiated only if the discovering did not result in other directions in which direct wireless exchange between the first one of the plurality of conference terminals the said second one of the plurality of conference terminals is possible, i.e. if there is no further possibility to remedy the situation by a further primary recovery. Accordingly, the secondary recovery phase would be initiated if the discovery revealed only one direct wireless exchange path between the given pair of conference terminals, which path is presently unavailable, or if the discovery revealed multiple direct wireless exchange paths between the given pair of conference terminals, all of which are presently unavailable.

In an embodiment of the method according to the present invention, the transceiver operates in an ISM band between 57 GHz and 66 GHz.

It is an advantage of this embodiment that it allows highly directional beam forming. It is a further advantage of this embodiment that it allows beams to bounce off walls, ceilings, or objects, thus increasing the chances of finding a path for direct wireless exchange between any two given locations in an indoor environment. It is a further advantage of this embodiment that it substantially confines the wireless transmissions to the indoor environment, which is a privacy benefit, as radio waves in this frequency range do not significantly traverse walls or structural elements. It is a further advantage of this embodiment that it uses an unlicensed band.

In an embodiment, the method according to the present invention further comprises: arranging reflectors in the indoor environment to provide additional physical paths corresponding to additional directions in which an exchange of signals between pairs of conference terminals is possible.

It is a further advantage of this embodiment that it allows directed electromagnetic radiation (beams) to bounce off judiciously placed reflectors, thus increasing the chances of finding a path for direct wireless exchange between any two given locations in an indoor environment. The reflectors according to this embodiment may be passive reflectors, i.e. objects whose geometry and material are chosen so as to be conducive to reflecting the radio waves emitted by the conference terminals, or active reflectors, i.e. devices capable of receiving and retransmitting the signals emitted by the conference terminals, thus acting as a (directional) repeater.

In an embodiment of the method according to the present invention, the conference terminals are adapted to visually and/or audibly signal, during the discovery phase, the detection of directions in which an exchange of signals with another one of the plurality of conference terminals.

This embodiment facilitates the setting up of the indoor environment, because it provides direct feedback about the availability of links to the installer, while the latter positions the conference terminals and/or reflectors.

In an embodiment, the method according to the present invention further comprises: running a spanning tree protocol between the plurality of conference terminals, wherein each switch-over between the first one and the second one of the number of directions in which the exchange of signals between the first one of the plurality of conference terminals and the second one of the plurality of conference terminals is possible occurs in accordance with the spanning tree protocol.

It is an advantage of this embodiment that it provides a logical network topology in which every conference terminal is able to communicate with every other conference terminal, either directly or through other conference terminals, without having any loops in the network. The various paths (or directions) that are available for transmission between a conference terminal and its peers are treated as different links for the purpose of the spanning tree protocol, each of which is assigned a different cost or weight. Depending on the application, this cost or weight may take into account signal-to-noise ratio, available bitrate, bit error rate, latency, link stability, and similar metrics. Thus, the selecting of the first direction and the second direction, as referred to above, occurs in accordance with the spanning tree protocol.

In a particular embodiment of the method according to the present invention, one of the plurality of conference terminals is an access point.

In this embodiment, the spanning tree ensures that every other conference terminal has a (and only one) connection to the access point, which coordinates the receipt and (re)transmission of the information (e.g., audio signals) of the conference delegates, and which may further provide access to another network (e.g., a wide-area network).

According to an aspect of the present invention, there is provided a computer program product comprising code means configured to cause a processor to carry out the steps of a conference terminal in a method as described above.

According to an aspect of the present invention, there is provided a wireless conferencing system comprising a plurality of conference terminals, each of the conference terminals being equipped a with transceiver adapted to operate in a first mode and a second mode, the first mode being an omnidirectional mode and the second mode being a directional mode, wherein each of the conference terminals is configured to: in a discovery phase, for each other conference terminal, discover a number of directions in which a direct wireless exchange of signals with the other conference terminal is possible, by operating the conference terminal in the first mode and the other conference terminal in the second mode and attempting to exchange first signals while the transceiver of the other conference terminal is operated so as to vary a direction of operation, or vice versa; for another one of the plurality of conference terminals, selecting a first one of the number of directions in which direct wireless exchange of signals with the other one of the plurality of conference terminals is possible as an active transmission direction; in an operational phase, send second signals to the other one of the plurality of conference terminals, using the active transmission direction; and, in a primary recovery phase, if a failure in the sending of the second signals is detected and if the discovering resulted in at least two directions in which the direct wireless exchange with the other conference terminal is possible, select a second one of the number of directions in which direct wireless exchange of signals with the other conference terminal is possible as a new active transmission direction, and send third signals to the other conference terminal, using the new active transmission direction.

In an embodiment of the system according to the present invention, each of the conference terminals is further configured to: in a secondary recovery phase, if a failure in the sending of the second signals is detected, send fourth signals to a third one of the plurality of conference terminals, using a first one of the number of directions in which the direct wireless exchange of signals with the third one of the plurality of conference terminals is possible, the third one of the plurality of conference terminals being used as a relay for reaching the other conference terminal.

In an embodiment of the system according to the present invention, the transceivers operate in an ISM band between 57 GHz and 66 GHz.

In an embodiment, the system according to the present invention further comprises reflectors arranged in the indoor environment to provide additional physical paths corresponding to additional directions in which an exchange of signals between pairs of conference terminals is possible.

In an embodiment of the system according to the present invention, the conference terminals are adapted to visually and/or audibly signal, during the discovery phase, the detection of directions in which an exchange of signals with another one of the plurality of conference terminals.

In an embodiment of the system according to the present invention, the conference terminals are further configured to run a spanning tree protocol, wherein each switch-over between directions in which the exchange of signals the other conference terminal is possible occurs in accordance with the spanning tree protocol.

In an embodiment of the system according to the present invention, one of the plurality of conference terminals is an access point.

According to an aspect of the present invention, there is provided a conference terminal for use in a method or a system as described above.

The technical effects and advantages of the embodiments of the computer program product, the system, and the conference terminal according to the present invention correspond mutatis mutandis to those of the corresponding embodiments of the method according to the present invention.

### BRIEF DESCRIPTION OF THE FIGURES

These and other technical effects and advantages of embodiments of the present invention will now be further described with reference to the accompanying drawings, in which:

FIG. 1 provides a flow chart of a method according to an embodiment of the present invention; and

FIG. 2 provides diagrams of a system according to an embodiment of the present invention in different phases.

### DESCRIPTION OF EMBODIMENTS

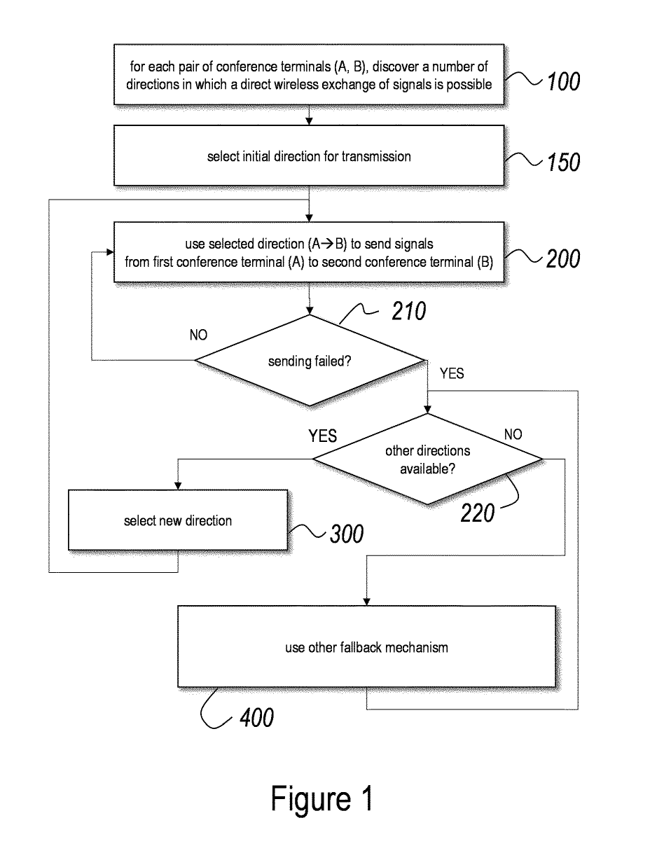

FIG. 1 provides a flow chart of a method for configuring a wireless conferencing system comprising a plurality of conference terminals in an indoor environment, according to an embodiment of the present invention. Each of the conference terminals is equipped with a transceiver adapted to operate in an omnidirectional mode and a directional mode, preferably a beam forming mode. The transceiver preferably operates in an ISM band between 57 GHz and 66 GHz, more preferably (for China) between 59 GHz and 64 GHz, or (for North America) between 57 GHz and 64 GHz. In a discovery phase 100, the directions in which a direct wireless exchange of signals is possible between each pair of conference terminals is discovered. This is done by operating one of each pair of conference terminals in omnidirectional mode and the other one in directional mode, the latter being configured to scan space so as to identify those directions in which an exchange of signals between both is successful.

The “scanning” occurs by cycling the antenna array of the transceiver through a range of parameters that correspond to different transmission directions. Optionally, the antenna array may be equipped with means to mechanically rotate it, such as a stepping motor, to provide greater spatial coverage. Optionally, the conference terminal may be equipped with a built-in reflector, to allow beams to be directed in further directions.

The identified directions may correspond to a straight (“line of sight”) communication path between both conference terminals, or to a communication path involving one or more reflections (e.g., a reflection off the ceiling). Generally, more than one communication path will be available, typically with increasing latency and decreasing signal-to-noise ratio for increasing numbers of intermediate reflections.

Based on the results of the discovery phase 100, and taking into account an appropriate cost function, a first one of the identified directions is selected as an initial direction for transmission 150. In an operational phase 200, signals are exchanged between a pair of conference terminals in directional mode, using the selected direction.

If the first path becomes unavailable due to interference, fading, temporary presence of an obstacle in the path, or the like (210, “YES” branch), the primary recovery phase is initiated. If more than one transmission direction was identified during discovery (220, “YES” branch), a second one of the identified directions is selected 300, and signals are then sent using the newly selected direction 200.

If no other direction is available for transmission (220, “NO” branch), the optional secondary recovery 400 may be initiated, in which signals are sent to another conference terminal, which then functions as a relay to reach the originally targeted conference terminal. The availability of directions for transmission may be checked intermittently or continuously, to allow the system to return to the regular operational phase 200 as soon as possible, upon selecting 300 an appropriate direction for transmission.

Additionally or alternatively, the secondary recovery 400 may include attempting to restore connectivity by using other available communication technology, such as IEEE Std 802.11 (“WiFi”) communication, mobile communication, and the like, if the conference terminals are equipped with the appropriate transceivers for that purpose.

The discovery phase 100 may be completed for all conference terminals prior to proceeding to the operational phase 200 for any of the terminals. Any pair of conference terminals may independently cycle through the operational phase 200, the primary recovery phase 300, and the secondary recovery phase 400 as necessary in function of the occurrence of disturbances. Optionally, one or more pairs of conference terminals may reinitiate a discovery phase 100 if it turns out to be impossible to communicate for a predetermined amount of time. Optionally, the conference terminals may include means to detect movement (such as an accelerometer), and the conference terminals may be configured to trigger a new discovery phase 100 when a predetermined amount of movement is detected.

The switch-over between the different available paths (directions) is preferably performed in accordance with a spanning tree protocol, to avoid loops in the network and to ensure efficient connectivity between an access point and each other conference terminal. Preferably, the conference terminals exchange information about the nature and quality of the connections they have (or can have) with their neighbors, so as to allow the selection of the most efficient active network topology. While a spanning tree protocol is typically a distributed protocol, it is also possible to let the access point select and impose a particular active network topology.

While most conference terminals will be present in or near a common horizontal plane (typically at desk height), the access point may be installed at a more elevated position, to increase the chance of having a line-of-sight connection between the access point and each other conference terminal. The position of the access point may be constrained by the availability of AC power and/or a wired network connection (e.g. an Ethernet connection).

In the assumption that most conference terminals will be present in or near a common horizontal plane, the information about the discovered line-of-sight paths between the various conference terminals (in particular, signal time-of-flight, latency and signal-to-noise ratio, which may be used to estimate link distance) may be used to produce a two-dimensional plan of the relative positions of the conference terminals. Such a plan may be useful to the conference organizers or moderators, so as to know which conference terminal is associated with which delegate.

Reflectors may be arranged in the indoor environment to provide additional physical paths corresponding to additional directions in which an exchange of signals between pairs of conference terminals is possible. While the reflectors are being (tentatively) positioned, the conference terminals may perform the discovery phase 100 and visually and/or audibly signal the detection of directions in which an exchange of signals with another one of the conference terminals is possible, thus giving the person(s) that are positioning the reflectors immediate feedback about the adequacy of the chosen positions.

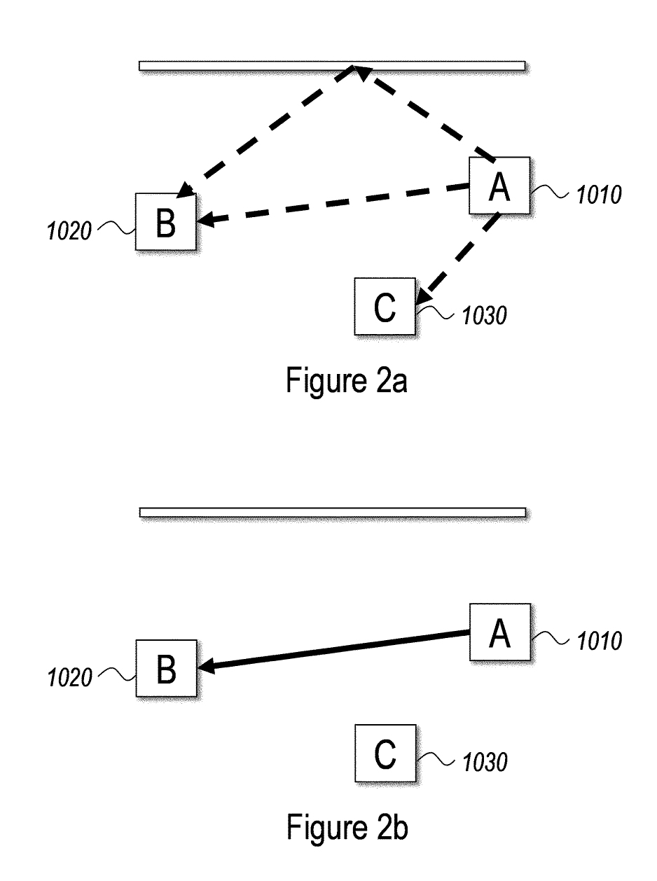

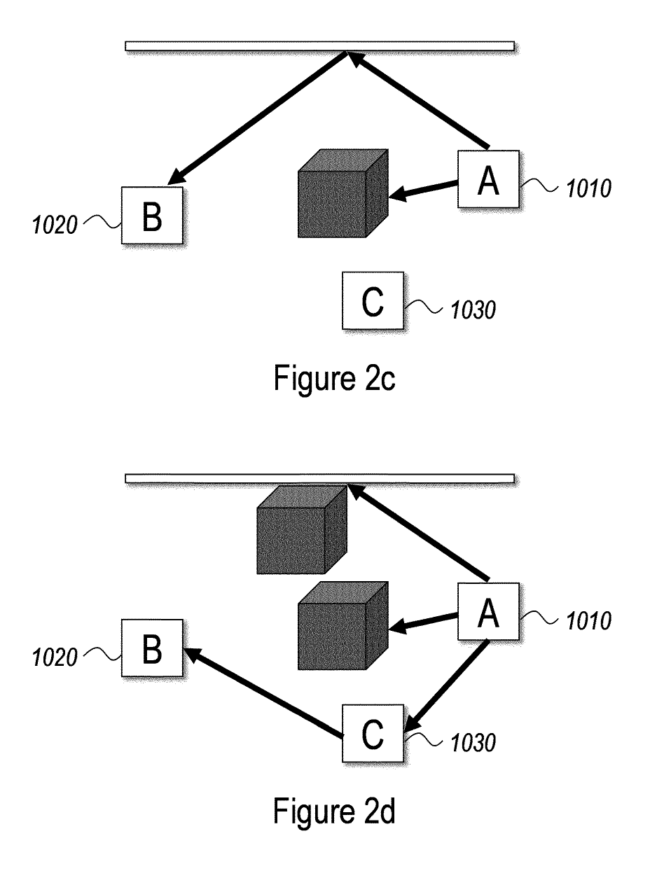

FIG. 2 provides diagrams of a system according to an embodiment of the present invention in different phases. Without loss of generality, three conference terminals 1010, 1020, 1030 are shown. In the illustrated example, conference terminal A 1010 attempts to communicate with conference terminal B 1020.

In FIG. 2a, representing the discovery phase 100, different transmission directions are discovered between conference terminal A 1010 (shown as transmitter) and its peers B 1020 and C 1030 (shown as receivers). Without loss of generality, the illustrated situation provides a direct wireless exchange, which is illustrated without loss of generality as a line-of-sight path, and a reflected path between conference terminal A 1010 and conference terminal B 1020. The illustrated situation also provides a single direct wireless exchange between conference terminal A 1010 and conference terminal C 1030. To keep the figures and the description concise, discovery between other pairs of conference terminals will not be discussed further.

In FIG. 2b, representing an initial operational phase 200, this communication takes place through the direct wireless exchange, in a first direction (A→B).

In FIG. 2c, representing a situation following the primary recovery phase 300, the line-of-sight path in the first direction (A→B) is temporarily blocked by an obstacle (schematically shown as a cube). Communication is reestablished by using a second direction (A→B)′, which uses a path reflecting off a reflector (e.g., a ceiling).

In FIG. 2d, representing the secondary recovery phase 400, the second direction is also blocked by an obstacle (schematically shown as a second cube). Communication is reestablished by using a first line-of-sight direction towards conference terminal C 1030 (A→C), where conference terminal C 1030 is used as a relay to reach conference terminal B 1020.

The system may cycle back and forth between the respective situations of FIGS. 2b, 2c, and 2d, as obstacles appear and disappear.

While the invention has been described hereinabove with respect to some specific examples, this was done to illustrate and not to limit the invention, the scope of which is defined by the attached claims. The skilled person will understand that any features and advantages described in connection with the method of the present invention may also be applied to the system of the present invention, and vice versa.

1. A method for configuring a wireless conferencing system comprising a plurality of conference terminals in an indoor environment, each of said conference terminals being equipped with a transceiver adapted to operate in a first mode and a second mode, said first mode being an omnidirectional mode and said second mode being a directional mode, the method comprising:
in a discovery phase, for each pair of conference terminals, discovering a number of directions in which a direct wireless exchange of signals between said pair of conference terminals is possible, by operating a first one of said pair of conference terminals in said first mode and a second one of said pair of conference terminals in said second mode and attempting to exchange first signals while said transceiver of said second conference terminal is operated so as to vary a direction of operation;
for a first one of said plurality of conference terminals and a second one of said plurality of conference terminals, selecting a first one of said number of directions in which said direct wireless exchange of signals between said first one of said plurality of conference terminals and said second one of said plurality of conference terminals is possible as an active transmission direction;
in an operational phase, sending second signals from said first one of said plurality of conference terminals to said second one of said plurality of conference terminals, using said active transmission direction; and,
in a primary recovery phase, if a failure in said sending of said second signals is detected and if said discovering resulted in at least two directions in which said direct wireless exchange between said first one of said plurality of conference terminals and said second one of said plurality of conference terminals is possible, selecting a second one of said number of directions in which said direct wireless exchange of signals between said first one of said plurality of conference terminals and said second one of said plurality of conference terminals is possible as a new active transmission direction, and sending third signals from said first one of said plurality of conference terminals to said second one of said plurality of conference terminals, using said new active transmission direction.

2. The method according to claim 1, further comprising:
in a secondary recovery phase, if a failure in said sending of said second signals or said sending of said third signals is detected, sending fourth signals from said first one of said plurality of conference terminals to a third one of said plurality of conference terminals, using a first one of said number of directions in which said direct wireless exchange of signals between said first one of said plurality of conference terminals and said third one of said plurality of conference terminals is possible, said third one of said plurality of conference terminals being used as a relay for reaching said second one of said plurality of conference terminals.

3. The method according to claim 1, wherein said transceiver operates in an ISM band between 57 GHz and 66 GHz.

4. The method according to claim 1, further comprising arranging reflectors in said indoor environment to provide additional physical paths corresponding to additional directions in which an exchange of signals between pairs of conference terminals is possible.

5. The method according to claim 1, wherein said conference terminals are adapted to visually signal, audibly signal, or both visually and audibly signal, during said discovery phase, the detection of directions in which an exchange of signals with another one of said plurality of conference terminals.

6. The method according to claim 1, further comprising running a spanning tree protocol between said plurality of conference terminals, wherein each switch-over between said first one and said second one of said number of directions in which said exchange of signals between said first one of said plurality of conference terminals and said second one of said plurality of conference terminals is possible occurs in accordance with said spanning tree protocol.

7. The method according to claim 6, wherein one of said plurality of conference terminals is an access point.

8. A computer program product comprising code means configured to cause a processor to carry out the steps of a conference terminal in a method according to claim 1.

9. A wireless conferencing system comprising a plurality of conference terminals, each of said conference terminals being equipped a with transceiver adapted to operate in a first mode and a second mode, said first mode being an omnidirectional mode and said second mode being a directional mode, wherein each of said conference terminals is configured to:
in a discovery phase, for each other conference terminal, discover a number of directions in which a direct wireless exchange of signals with said other conference terminal is possible, by operating said conference terminal in said first mode and said other conference terminal in said second mode and attempting to exchange first signals while said transceiver of said other conference terminal is operated so as to vary a direction of operation, or vice versa;
for another one of said plurality of conference terminals, selecting a first one of said number of directions in which said direct wireless exchange of signals with said other one of said plurality of conference terminals is possible as an active transmission direction;
in an operational phase, send second signals to said other one of said plurality of conference terminals, using said active transmission direction; and,
in a primary recovery phase, if a failure in said sending of said second signals is detected and if said discovering resulted in at least two directions in which said direct wireless exchange with said other conference terminal is possible, select a second one of said number of directions in which said direct wireless exchange of signals with said other conference terminal is possible as a new active transmission direction, and send third signals to said other conference terminal, using said new active transmission direction.

10. The system according to claim 9, wherein each of said conference terminals is further configured to:
in a secondary recovery phase, if a failure in said sending of said second signals is detected, send fourth signals to a third one of said plurality of conference terminals, using a first one of said number of directions in which said direct wireless exchange of signals with said third one of said plurality of conference terminals is possible, said third one of said plurality of conference terminals being used as a relay for reaching said other conference terminal.

11. The system according to claim 9, wherein said transceivers are configured to operate in an ISM band between 57 GHz and 66 GHz.

12. The system according to claim 9, further comprising reflectors arranged in said indoor environment to provide additional physical paths corresponding to additional directions in which an exchange of signals between pairs of conference terminals is possible.

13. The system according to claim 9, wherein said conference terminals are adapted to visually signal, audibly signal, or both visually and audibly signal, during said discovery phase, the detection of directions in which an exchange of signals with another one of said plurality of conference terminals is possible.

14. The system according to claim 9, wherein said conference terminals are further configured to run a spanning tree protocol, wherein each switch-over between directions in which said exchange of signals said other conference terminal is possible occurs in accordance with said spanning tree protocol.

15. The system according to claim 14, wherein one of said plurality of conference terminals is an access point.

16. The system according to claim 10, wherein said transceivers are configured to operate in an ISM band between 57 GHz and 66 GHz.

17. The system according to claim 10, further comprising reflectors arranged in said indoor environment to provide additional physical paths corresponding to additional directions in which an exchange of signals between pairs of conference terminals is possible.

18. The system according to claim 10, wherein said conference terminals are adapted to visually signal, audibly signal, or both visually and audibly signal, during said discovery phase, the detection of directions in which an exchange of signals with another one of said plurality of conference terminals is possible.

19. The system according to claim 10, wherein said conference terminals are further configured to run a spanning tree protocol, wherein each switch-over between directions in which said exchange of signals said other conference terminal is possible occurs in accordance with said spanning tree protocol.

20. The system according to claim 19, wherein one of said plurality of conference terminals is an access point.
